(19) United States
(12) Patent Application Publication
(10) Pub. No.: US 2005/0129792 A1
(43) Pub. Date: Jun. 16, 2005

(54) Device for producing granules

(76) Inventors: Matthias Kleinhans, Waiblingen (DE); Dietmar Hafele, Winterbach (DE); Stephan Gierke, Bremen (DE)

Correspondence Address: BURNS DOANE SWECKER & MATHIS L L P, POST OFFICE BOX 1404, ALEXANDRIA, VA, 22313-1404, US

(21) Appl. No.: 10/488,282

(22) PCT Filed: Aug. 7, 2002
(86) PCT No.: PCT/EP02/08803

(30) Foreign Application Priority Data
Sep. 3, 2001 (DE) 101 44 257.2

(51) Int. Cl. B29B 9/10

(52) U.S. Cl. 425/6; 425/375

(57) ABSTRACT

A belt drop shaper forms a viscous substance into the shape of drops. The drop shaper includes a container for the substance and a perforated steel belt pressing against a bottom surface of the container. The bottom surface includes at least one discharge opening that is periodically opened by perforations in the belt to enable drops of the substance to fall on a transport conveyor. A heater unit is provided, e.g., in a support drum around which the steel belt travels, to heat the steel belt at a location upstream of the discharge opening.

### BACKGROUND OF THE INVENTION

The invention relates to a device for the production of granulates made of flowable, viscous substances comprising a container supplied with the substances having at least one discharge opening that is periodically opened and closed by a passing perforated belt so that the substances fall from the orifices in the form of drops onto a conveyor belt traveling below, particularly a belt designed as a cooling belt on which said substances solidify.

A device of this type is disclosed in EP 0 134 944 B1 (corresponding to Froeschke U.S. Pat. No. 4,559,000). An endless revolving perforated belt made of synthetic material is provided to maintain sufficient elasticity while rotating around drums of small diameters and to maintain contact with the discharge opening of the container. However, the use of plastic synthetic belts leads to relatively high wear of the belts.

It has been proposed therefore in German Patent 43 32 953 (corresponding to Froeschke U.S. Pat. No. 5,766,642) to use a very thin perforated steel belt in place of the synthetic plastic belt whereby this steel is suitable to be used in a device of the aforementioned type instead of the plastic belt. However, since such a metal belt does not have the sufficient thickness to offer the necessary portion volume in the pickup of the substance to be dripped during the drop producing process, there are arranged outwardly projecting nozzles on the steel belt on all perforated openings at the side facing away from the container in order not to negatively influence the guidance of the belt and still serve to pick up the necessary portion volume. Belts of this type are relatively costly in their production. They have also the disadvantage, just like the traditionally used synthetic plastic belt, that relatively costly heating equipment has to be provided in the area of the drop-forming point to ensure necessary heating of the substances to be dripped and to avoid, at least at this point, premature solidifying of the material exiting the orifices.

The present invention is based on the object to achieve heating at the drop-forming apertures on the belt.

### SUMMARY OF THE INVENTION

Based on the premise that, for example, steel belts provided on a belt press have the necessary thickness for a drop-forming process and have excellent heating retention capability, it is proposed in the achievement of the object for a device of the aforementioned type that a steel belt used as a perforated belt has the sufficient thickness for the drop-forming process whereby said steel belt is guided around guide drums having sufficiently large diameters to prevent forming of cracks at the orifices, and whereby a heating element is arranged for the steel belt at least at a distance upstream from the drop-forming point. This measure requires, nevertheless, that guide drums in the range of approximately 1,000 mm have to be used in the employment of steel belts having a thickness between 1 mm and 4 mm, as they are also used in belt presses, whereby the heating capacity of such a steel belt is suitable in an extremely advantageous manner to be provided in a device of the aforementioned type. It has been shown that the drop-forming process can be surprisingly performed with different viscous substances at specific temperatures whereby heating of the steel belt can be respectively adjusted to the type of application. The employed smooth steel belts are of simple construction, very resistant to wear, and they can be easily cleaned as well.

In development of the invention, it is possible to arrange in a relatively simple manner the heating unit in the interior, at least in the guide drum that is disposed in front of the drop-forming process in the direction of movement of the lower flight of the steel belt. The interior of this large guide drum has easily enough space for all conceivable kinds of heating units with which the guide drum itself and also the perforated steel belt can be heated.

In an additional embodiment of the invention, the discharge opening of the container supplied with the substances to be dripped can be designed as a groove-like recess extending across the width of the belt and running transversely to the movement direction of the steel belt whereby said recess leads to the surface of the container that rests against the steel belt. This groove-like recess can be designed wide enough in the direction of the belt movement to reach the desired drop size which then forms the desired granulates on the cooling belt below after the solidifying of the respective drops.

The discharge opening can also be in the form of a plurality of groove-like recesses running parallel to one another and extending transversely to the movement direction of the steel belt whereby all recesses lead to the surface of the container that rests against the steel belt. It has been shown that such a design is more favorable for the drop-forming process of some particular substances. In both cases-which also includes the use of a relatively wide groove-like recess in the direction of the belt movement—the relatively thick steel belt provided according to the invention offers the advantage that it does not force itself into the groove-like recess even though it is pressed firmly against the surface of the container facing outwardly.

In development of the invention, the surface of the container resting against the steel belt may be shaped slightly convex and it is made possible to let the steel belt lie against the convex surface of the container under initial tension.

### BRIEF DESCRIPTION OF THE DRAWINGS

The invention is illustrated in the drawings with the aid of embodiment examples and it is described in the following.

FIG. 1 shows a schematic side view of a device according to the invention;

FIG. 2 shows an enlarged illustration of a longitudinal section of the container in FIG. 1 pertaining to the lower flight of the endless revolving steel belt;

FIG. 3 shows a sectional illustration, similar to FIG. 2; yet of another embodiment of the container.

### DESCRIPTION OF PREFERRED EMBODIMENTS OF THE INVENTION

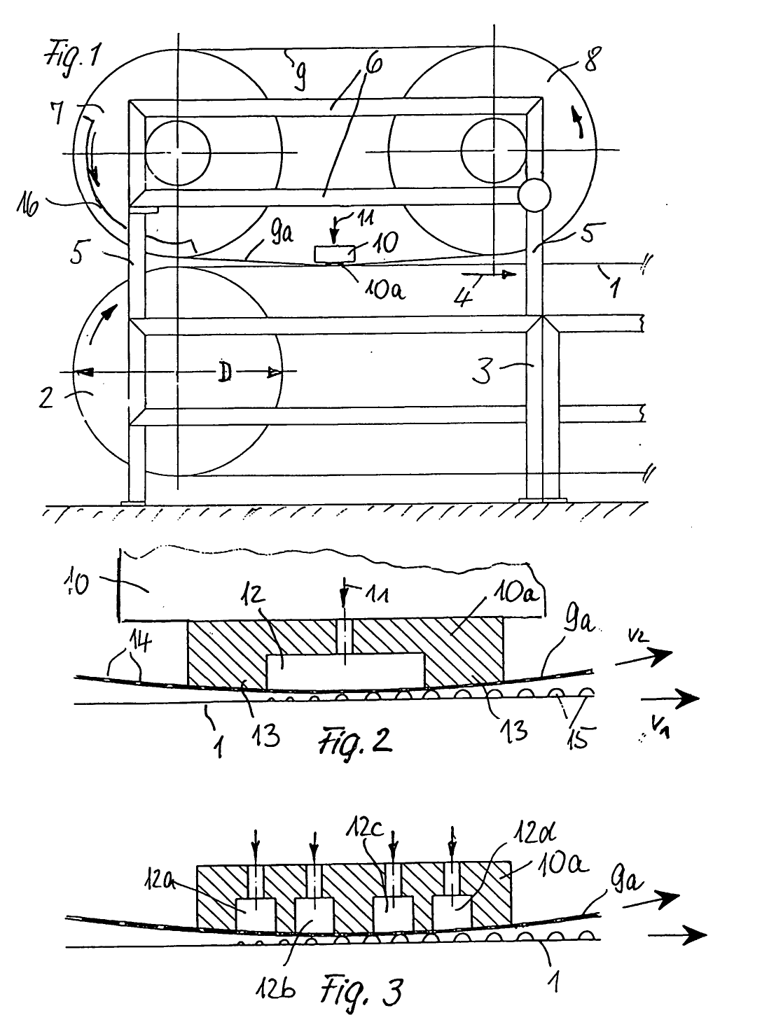

FIG. 1 shows that an endless revolving steel transport belt 1, which is designed as a cooling belt in a not further described manner, is held in a machine stand 3 with the aid of two guide rollers, of which only the guide roller 2 is shown. The cooling steel belt revolves in the direction of arrow 4. The depicted guide roller 2 has a diameter D of approximately 1,000 mm.

Two additional guide rollers 7 and 8 of approximately the same diameter as the one of the guide roller 2 are proposed to be in the machine stand 3, which is provided with a support frame 6 on vertical support pieces 5 extending upwardly. Said guide rollers 7 and 8 serve as guide and drive for an additional endless steel belt 9 that is perforated nearly across its entire width—which is only indicated in FIG. 2 and FIG. 3.

A lower flight 9a of the perforated steel belt 9 passes by the container 10, which is supplied with a flowable viscous substance in the direction of arrow 11 in a known manner, which is not further illustrated, whereby said substance is then deposited in drop form on the cooling belt 1 in a manner yet to be described with the aid of FIG. 2 and FIG. 3.

The container 10, which can be seen in a first embodiment in FIG. 2, is also connected to either the frame 6 or the support pieces 5 so that it can be held in a specific position in which it extends transversely to the inner surface of the lower flight 9a of the belt. Its discharge opening 12 lies against the lower flight 9a in this position whereby said lower flight 9a is kept under initial tension and it rests securely and tightly against a drop-forming station defined by said discharge opening.

A heating unit in the form of a radiant heater 16 or in the form of an oil heater is arranged in the large cavity of at least the drum 7 whereby said heating unit extends along a double shell of the guide drum 7. Other controllable heating devices are also conceivable. A deciding factor is that the heating device must be controllable and adjustable so that the steel belt 9 leading around the guide drum 7 has a certain temperature when it reaches the mouthpiece 10a of the container 10. The container 10 and its mouthpiece 10a itself are also heated by a suitable heating device to such a degree that a specific viscosity of the substance to be dripped is maintained. The temperature of the steel belt 9 is to be matched to this temperature to prevent the viscosity from changing in an undesirable manner and alters thereby the ability of drop-forming of the substance to be processed within the borings 14. This type of heating can be very easily achieved with the novel perforated steel belt 9 since the heat retention characteristics of the steel belt can be exploited. Appropriate controllable heating devices may be accommodated without any difficulties in the large cavity of drum 7 and, of course, in drum 8 as well.

FIG. 2 shows that the discharge opening 2 is designed as a groove-like recess arranged in a mouthpiece 10a of the container 10 whereby said mouthpiece 10a is a part of the container 10. The mouthpiece 10a is designed essentially in the way of a strip extending transversely across the lower flight 9a of the belt whereby the legs 13 on both sides of the recess 12 are provided with a slightly convex outer surface which is forced against the lower flight 9a. Contact of the steel belt 9 against the mouthpiece 10a can be achieved in a simple manner in that the distance between the two guide rollers 7 and 8 can be changed to a certain degree so that the lower flight 9a can be brought thereby into contact with the mouthpiece 10 under the desired initial tension.

As depicted in FIG. 2, the apertures 14 arranged in the steel belt 9 arrive in the area of the recess 12, one after the other, whereby material enters the aperture 14 urged by the pressure of the substance located in said recess, and whereby said material is pushed out downwardly more and more out of said aperture during travel of the aperture across through the width of the recess 12 in the direction of component V₂ and said material remains on the belt 1 in the form of drops 15 and said drops subsequently solidify on the belt. The width of the recess 12 and the rotational velocity of the belt 9 contribute thereby to the forming of drops whereby, of course, the thickness of the belt 9 and the size of the apertures 14 play a role in the adjustment of viscosity of the substance to be dripped.

In addition, one must keep in mind that the rotational velocity V₂ of the steel belt 9 and the rotational velocity V₁ of the cooling belt 1 should match if forming of drops is to occur in the manner mentioned above.

FIG. 3 shows a variant of the mouthpiece 10a to the extent that not one through-going recess 12 is provided but there are provided a plurality of recesses 12a through 12d in the mouthpiece 10a which extend respectively across the entire width of the belt—or in any case, across the region that is perforated, to define a drop-forming station. It can be seen without any difficulty that the desired forming of drops occurs also in this instant, and whereby in this case the rotational velocity of the steel belt 9 as wells as the rotational velocity of the steel belt 1 should be the identical.

1-7. (canceled)

8. Apparatus for producing granules from a flowable, viscous substance, the apparatus comprising:
a container for the substance, the container having at least one discharge opening defining a drop-forming station;
a transport conveyor traveling beneath the drop-forming station;
a perforated steel belt arranged to travel around first and second guide drums and across the discharge opening in a downstream direction to thereby periodically open the discharge opening to permit viscous substance to pass through orifices formed in the steel belt and fall onto the transport conveyor;
the first and second guide drums having respective diameters large enough to prevent the formation of cracks at the orifices in the steel belt; and
a heating unit positioned at a location upstream of the drop-forming station for heating the steel belt.

9. The apparatus according to claim 8 wherein the first and second drums are spaced upstream and downstream, respectively, from the drop-forming station, the heating unit disposed inside the first drum.

10. The apparatus according to claim 8 wherein the discharge opening comprises a groove extending across a substantial portion of a width of the steel belt in a direction transversely of the downstream direction of belt travel, the steel belt bearing against a surface of the container in which the groove is formed.

11. The apparatus according to claim 10 wherein the container includes a substance-containing portion and a mouthpiece portion disposed therebeneath and communicating with an interior of the substance-containing portion.

12. The apparatus according to claim 11 wherein the surface of the container against which the steel belt bears is disposed on the mouthpiece portion, and is convexly curved.

13. The apparatus according to claim 8 wherein the at least one discharge opening comprises a plurality of discharge openings each comprising parallel grooves disposed next to one another in a direction transversely of the downstream direction of belt travel, the steel belt bearing against a surface of the container in which the grooves are formed.

14. The apparatus according to claim 13 wherein the container includes a substance-containing portion and a mouthpiece portion disposed therebeneath and communicating with an interior of the substance-containing portion.

15. The apparatus according to claim 14 wherein the surface of the container against which the steel belt bears is disposed on the mouthpiece portion, and is convexly curved.

16. The apparatus according to claim 8 wherein the steel belt slides across a bottom surface of the container under tension.
